(19) United States
(12) Patent Application Publication
(10) Pub. No.: US 2023/0086194 A1
(43) Pub. Date: Mar. 23, 2023

(54) NON-AQUEOUS ELECTROLYTE SECONDARY BATTERY AND METHOD FOR MANUFACTURING NON-AQUEOUS ELECTROLYTE SECONDARY BATTERY

(71) Applicant: SANYO Electric Co., Ltd., Kadoma-shi, Osaka (JP)

(72) Inventors: Katsuya Shiozaki, Hyogo (JP); Masumi Terauchi, Hyogo (JP)

(73) Assignee: SANYO Electric Co., Ltd., Kadoma-shi, Osaka (JP)

(21) Appl. No.: 17/908,360

(22) PCT Filed: Feb. 8, 2021
(86) PCT No.: PCT/JP2021/004626

§ 371 Date: Aug. 31, 2022

(30) Foreign Application Priority Data
Mar. 6, 2020 (JP) 2020-038294

(51) Int. Cl. H01M 10/04; H01M 4/36

(52) U.S. Cl. CPC H01M 10/0468; H01M 4/362; H01M 2004/021

(57) ABSTRACT

The positive electrodes each have a core-body exposed part at which a positive electrode core body is exposed, and a base part in which a composite material layer is formed on at least one surface of the positive electrode core body. The base part has formed therein a first region in which an active material is embedded in the positive electrode core body and a second region in which the the average embedment depth of active material embedded in the positive electrode core body is smaller than that in the first region. The second region is formed adjacent to the core-body exposed part.

### TECHNICAL FIELD

The present disclosure relates to a non-aqueous electrolyte secondary battery and a method for manufacturing the same.

### BACKGROUND

A non-aqueous electrolyte secondary battery includes a non-aqueous electrolyte and an electrode assembly in which positive electrodes and negative electrodes are alternately stacked via separators. Each of the positive or negative electrodes includes a core exposed portion in which the core is exposed, and a base portion in which a composite material layer is formed on at least one side of the core. A method for manufacturing these positive and negative electrodes includes a coating step to apply a composite material slurry including an active material to a long piece of metal foil except for exposed portions including the core exposed portion. The manufacturing method further includes a compressing step to form a composite material layer on the metal foil by drying and rolling the coating, and a cutting step to cut the metal foil on which the composite material layer has been formed into a preset shape (for example. Patent Literature 1).

### CITATION LIST

### Patent Literature

Patent Literature 1: JP 2014-179217 A

### SUMMARY

In positive or negative electrodes of a non-aqueous electrolyte secondary battery, a composite material layer can easily peel off from a core around an edge portion, which is formed from the core and the composite material layer. In particular, in a cutting step of the positive or negative electrodes for the non-aqueous electrolyte secondary battery, the composite material layer can easily peel off from the metal foil during cutting the metal foil with the composite material layer using a slitter or other means. One solution may be to increase the adhesion strength (binding force) between the core and the composite material layer to avoid peeling. Such a stronger binding force between the core and the composite material layer, however, reduces the strength of the core.

Tabs are formed in the core exposed portions of the positive or negative electrodes of the non-aqueous electrolyte secondary battery. When the tabs are fastened to current collectors by welding or other means, vibrations and impacts may occur. When the binding force between the core and the composite material layer is increased, there is a risk that the electrode may be torn, for example, at a composite material layer coated portion around the boundary with the core exposed portion. In a coating step of the positive or negative electrodes of the non-aqueous electrolyte secondary battery, a composite material slurry is applied to a long piece of metal foil except for around both longitudinal edge portions extending along the feeding direction of the metal foil to leave the edge portions as the exposed portions. A stress can be concentrated on the edge portions of the metal foil extending along the feeding direction due to torsion of the metal foil or other causes. When the binding force between the metal foil and the composite material layer is increased as described above, the electrode may be torn at the composite material layer coated portion around the boundary with the exposed portion.

A non-aqueous electrolyte secondary battery according to an aspect of the present disclosure includes a non-aqueous electrolyte and an electrode assembly in which positive electrodes and negative electrodes are alternately stacked via separators. Each of the positive or negative electrodes includes a core exposed portion in which a core is exposed, and a base portion in which a composite material layer is formed on at least one side of the core. The base portion includes a first region in which an active material is embedded in the core, and a second region in which the average embedment depth of the active material in the core is smaller than that in the first region. The second region is located next to the core exposed portion.

A method for manufacturing a non-aqueous electrolyte secondary battery according to an aspect of the present disclosure is a method to manufacture a non-aqueous electrolyte secondary battery which includes a non-aqueous electrolyte and an electrode assembly in which positive electrodes and negative electrodes are alternately stacked via separators. Each of the positive or negative electrodes includes a core exposed portion in which a core is exposed, and a base portion in which a composite material layer is formed on at least one side of the core. The method includes applying a composite material containing an active material to at least one side of a metal foil that forms the core, leaving an exposed portion that includes the core exposed portion to manufacture the plurality of positive electrodes or the plurality of negative electrodes. In the coating, the composite material is applied to form a first coating portion and a second coating portion next to the first coating portion such that the amount of coating per unit area in the second coating portion is less than that in the first coating portion.

An embodiment according to the present disclosure can prevent the composite material layer from peeling off the core and the electrode from tearing at the composite material layer coated portion around the boundary with the core exposed portion.

### BRIEF DESCRIPTION OF DRAWINGS

Embodiments of the present disclosure will be described based on the following figures, wherein:

FIG. 1 is a perspective view of a non-aqueous electrolyte secondary battery according to an embodiment of the present disclosure;

FIG. 2 is a perspective view of an electrode assembly according to an embodiment of the present disclosure;

FIG. 3 is a front view of a positive electrode according to an embodiment of the present disclosure;

FIG. 4 is a schematic diagram showing a positive electrode active material in close contact with a positive electrode core in a first region;

FIG. 5 is a schematic diagram showing the positive electrode active material in close contact with the positive electrode core in a second region;

FIG. 6 is a diagram used to illustrate a manufacturing process of the positive electrode according to an embodiment of the present disclosure;

FIG. 7 is a cross section cut along line A-A in FIG. 6 before compression; and

FIG. 8 is a cross section cut along line A-A in FIG. 6 after compression.

### DESCRIPTION OF EMBODIMENTS

Embodiments according to the present disclosure are described below with reference to the drawings. Shapes, materials, and numbers described below are merely examples and may be changed as required in accordance with specifications of the non-aqueous electrolyte secondary battery or the method for manufacturing the same. In description below, the same reference numerals are assigned to similar corresponding elements throughout all the drawings.

### Non-Aqueous Electrolyte Secondary Battery

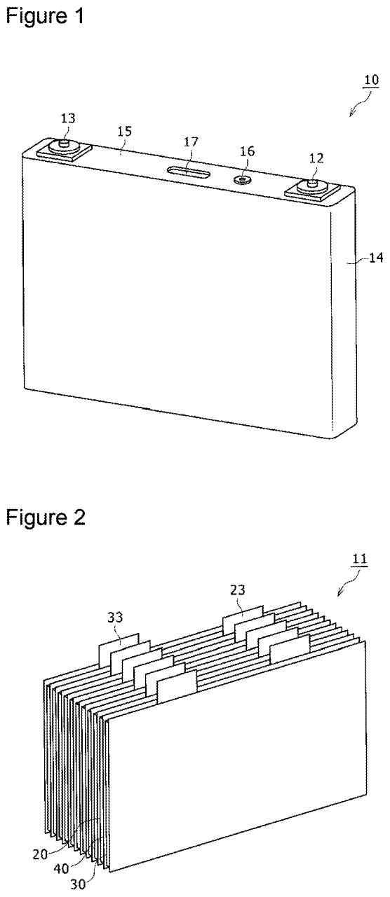

FIG. 1 is a perspective view of a non-aqueous electrolyte secondary battery 10 according to an embodiment of the present disclosure. As shown in FIG. 1, the non-aqueous electrolyte secondary battery 10 includes an electrode assembly 11 (refer to FIG. 2), a non-aqueous electrolyte, a can housing 14, and a sealing plate 15. The can housing 14 has a rectangular prism shape with a closed bottom and encloses the electrode assembly 11 and the non-aqueous electrolyte. The sealing plate 15 seals the top opening of the can housing 14. The non-aqueous electrolyte secondary battery 10 is a rectangular battery type. The can housing 14 is a metal container that has a substantially thin cuboid shape with one of the vertical ends opened. The sealing plate 15 has a long rectangular shape. The can housing 14 and the sealing plate 15 may be made from metal materials in which, for example, aluminum is the predominant component.

The non-aqueous electrolyte secondary battery 10 includes a positive electrode terminal 12 that is electrically connected to positive electrodes 20 (refer to FIG. 2) via positive electrode current collectors, and a negative electrode terminal 13 that is electrically connected to negative electrodes 30 (refer to FIG. 2)via negative electrode current collectors. In the present embodiment, the positive electrode terminal 12 is disposed at one longitudinal end of the sealing plate 15 and the negative electrode terminal 13 is disposed at the other longitudinal end of the sealing plate 15. The positive electrode terminal 12 and the negative electrode terminal 13 are externally connectable terminals which may be electrically connected to another non-aqueous electrolyte secondary battery 10, a circuit, or other devices. The positive electrode terminal 12 and the negative electrode terminal 13 are attached to the sealing plate 15 via insulation elements. The sealing plate 15 includes a solution inlet 16 and a gas outlet valve 17. A non-aqueous electrolyte solution is injected through the solution inlet 16 into the can housing 14 in which the electrode assembly 11 is enclosed. The gas outlet valve 17 is opened to discharge gas in case of a battery failure.

In the description below, the height direction of the can housing 14 is referred to as the “vertical” direction of the non-aqueous electrolyte secondary battery 10 with the sealing plate 15 side deemed as the “top” and the bottom of the can housing 14 deemed as the “bottom”. The direction along which the sealing plate 15 extends is referred to as the “horizontal” direction of the non-aqueous electrolyte secondary battery 10.

### Non-Aqueous Electrolyte

The non-aqueous electrolyte may contain, for example, a non-aqueous solvent and electrolyte salt dissolved in the non-aqueous solvent. The non-aqueous solvent may be, for example, esters, ethers, nitriles, amides, or a mixture of two or more of these groups. The non-aqueous solvent may contain a halogen substituent in which at least hydrogen in the solvents is at least partially replaced by halogen atoms, such as fluorine. As the electrolyte salt, a lithium salt, such as LiPF₆, may be used.

### Electrode Assembly

FIG. 2 is a perspective view of the electrode assembly 11. As shown in FIG. 2, the electrode assembly 11 is a multilayered electrode assembly in which the positive electrodes 20 and the negative electrodes 30 are alternately stacked one behind the other via separators 40. Each of the positive electrodes 20 or the negative electrodes 30 includes a positive electrode tab 23 or a negative electrode tab 33 projecting from the top. The positive electrodes 20 are stacked such that the positive electrode tabs 23 are positioned at the same horizontal end of the electrode assembly 11 and line up in the depth direction of the electrode assembly 11. The negative electrodes 30 are stacked such that the negative electrode tabs 33 are positioned at the other horizontal end of the electrode assembly 11 and line up in the depth direction of the electrode assembly 11.

### Positive Electrodes

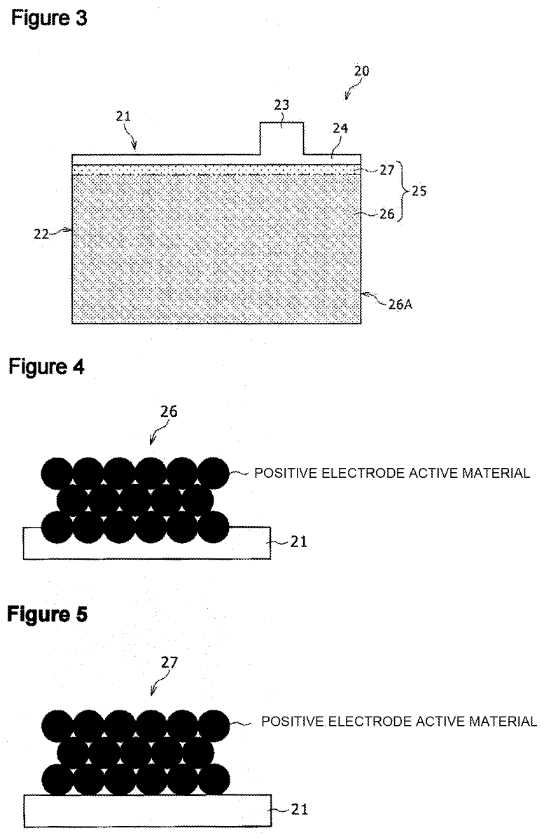

FIG. 3 shows a front view of the positive electrode 20. As shown in FIG. 3, each positive electrode 20 includes a positive electrode core 21 and a positive electrode composite material layer 22 formed on each side of the positive electrode core 21. The positive electrode core 21 may be a metal foil which is made of a material stable in the battery operational voltage range, such as aluminum, or a film or the like coated with such a metal. The thickness of the positive electrode core 21 may be, for example, 5 μm to 20 μm, more preferably, 8 μm to 15 μm.

The positive electrode composite material layer 22 contains, for example, a positive electrode active material, a conductive material, and a binding material. The positive electrode composite material layer 22 is disposed on each side of the positive electrode core 21. The thickness of each positive electrode composite material layer 22 on each side of the positive electrode core 21 is, for example, 40 μm to 120 μm, more preferably, 50 μm to 80 μm. Each positive electrode 20 may be manufactured by forming the positive electrode composite material layer 22 on each side of the positive electrode core 21 by applying a positive electrode composite material slurry including a positive electrode active material, a conductive material, a binding material, and other materials to the positive electrode core 21, and drying and compressing the coating, and then cutting into a preset shape.

A lithium transition metal composite oxide may be used as the positive electrode active material. The lithium transition metal composite oxide may contain metal elements, such as, Ni, Co, Mn, Al, B, Mg, Ti, V, Cr, Fe. Cu, Zn, Ga, Sr, Zr. NbIn, Sn, Ta, and W. Among these metal elements, the lithium transition metal composite oxide may contain, in particular, at least one of Ni, Co, and Mn. Preferable examples of the composite oxide are a lithium transition metal composite oxide which contains Ni, Co, and Mn, or Ni, Co, and Al.

The conductive material contained in the positive electrode composite material layer 22 may be, for example, a carbon material, such as carbon black, acetylene black, ketjen black, and graphite. The binding material contained in the positive electrode composite material layer 22 may be, for example, a fluororesin, such as polytetrafluoroethylene (PTFE) and polyvinylidene fluoride (PVDF), polyacrylonitrile (PAN), a polyimide resin, an acrylic resin, or a polyolefin resin. These resins may be used together with carboxymethyl cellulose (CMC) or its salt or other cellulose derivative, or with polyethylene oxide (PEO), or the like.

Each positive electrode 20 includes a core exposed portion 24 in which the positive electrode core 21 is exposed, and a base portion 25 in which the positive electrode composite material layer 22 is formed on at least one side of the positive electrode core 21. In the present embodiment, the positive electrode composite material layer 22 is disposed on each side of the positive electrode core 21. The core exposed portion 24 extends in the horizontal direction like a strip along the upper edge of the positive electrode 20. The positive electrode tab 23 described above is disposed at the upper edge of the core exposed portion 24. The base portion 25 indicates the entire positive electrode 20 except for the core exposed portion 24.

The base portion 25 includes a first region 26 and a second region 27. In the first region 26, a positive electrode active material is embedded in the positive electrode core 21. In the second region 27, the positive electrode active material is not embedded in the positive electrode core 21 as deep as in the first region 26. In the first region 26, the positive electrode active material is embedded in the positive electrode core 21 to a substantially constant depth. In the first region 26, an edge portion 26A except at a boundary with the second region 27 is formed from the positive electrode core 21 and the at least one positive electrode composite material layer 22. At the edge portion 26A, the positive electrode composite material layer 22 may easily peel off the positive electrode core 21.

The second region 27 is located next to the core exposed portion 24. The second region 27 may be formed within an area of 10 mm or less from the border with the core exposed portion 24. When the positive electrode tab 23 is welded or fastened by other means, vibrations and impacts may act to the second region 27. There is thus a risk that the electrode tears in the second region 27.

FIG. 4 is a schematic diagram showing the positive electrode active material in close contact with the positive electrode core 21 in the first region 26. As shown in FIG. 4, in the first region 26, the positive electrode active material is embedded in the positive electrode core 21. This increases the binding force between the positive electrode core 21 and the positive electrode composite material layer 22 in the first region 26. It thus becomes possible to prevent the positive electrode composite material layer 22 from peeling off the positive electrode core 21 in the first region 26 at the edge portion 26A that is formed from the positive electrode core 21 and the at least one positive electrode composite material layer 22.

In the first region 26, the surface curve rate of the positive electrode core 21 achieved with the positive electrode material embedded in the positive electrode core 21 may be 110% to 150%, more preferably 130% to 140%. The surface curve rate of the positive electrode core 21 is an indicator of the surface roughness of the positive electrode core 21, indicating the ratio of length along the concave or convex surface (with the positive electrode material embedded) per unit length of an otherwise flat surface (with the positive electrode material not embedded) of the positive electrode core 21 in the vertical or horizontal cross section. The surface curve rate of the positive electrode core 21 may be measured by observing the cross section of the positive electrode 20 using a scanning electron microscope (SEM).

The average embedment depth of the positive electrode active material in the positive electrode core 21 in the second region 27 is smaller than that in the first region 26. The average embedment depth is the average of the embedment depth of the positive electrode active material in the positive electrode core 21. The embedment depth is the length of the positive electrode core in the thickness direction from the surface of the positive electrode core to the deepest point to which the positive electrode active material reaches into the positive electrode core. The embedment depth of the positive electrode active material can be measured by observing the cross section of the positive electrode 20 using a scanning electron microscope (SEM).

FIG. 5 is a schematic view showing the positive electrode active material in close contact with the positive electrode core 21 in the second region 27. As shown in FIG. 5, the positive electrode active material may include a portion not embedded in the positive electrode core 21, or a portion embedded in the positive electrode core 21 but having the average embedment depth not as deep as in the first region 26. In the second region 27, the portions not embedded in the positive electrode core 21 may be formed on the core exposed portion 24 side, whereas the portions embedded in the positive electrode core 21 may be formed on the first region 26 side. In the second region 27, the positive electrode active material may be entirely unembedded, or embedded at a constant depth.

The surface curve rate per unit area of the positive electrode core 21 in the second region 27 may be lower than that of the positive electrode core 21 in the first region 26. In the first region 26, the surface curve rate of the positive electrode core 21 achieved with the positive electrode active material embedded in the positive electrode core 21 may be 100% to 110%.

In the above manner, a strength of the positive electrode core 21 in the second region 27 becomes higher than that in the first region 26. This can prevent the electrode in the second region 27 from being torn by vibrations or impacts caused when the positive electrode tab 23 is fastened to the positive electrode current collector by welding or other means.

The positive electrode active material may contain a lithium transition metal composite oxide of large particle diameters and a lithium transition metal composite oxide of particle diameters smaller than the large particle diameters. For example, in the first region 26, the positive electrode active material of large particle diameters and the positive electrode active material of small particle diameters may be embedded in the positive electrode core 21, or only positive electrode active material of large particle diameters may be embedded in the positive electrode core 21. The density of the positive electrode composite material layer 22 can be improved by mixing the positive electrode active materials of large and small particle diameters.

The positive electrode active material of large particle diameters may have the volume-based median size (hereinafter referred to as “D50”) of, for example, 15 μm or larger, more preferably, 15 μm to 20 μm. The positive electrode active material of small particle diameters may have the volume-based D50 of 5 μm or larger, more preferably, 5 μm to 10 μm. The volume-based D50 represents the particle diameter when the cumulative percentage reaches 50% from the smaller particle diameter in the volume-based particle-size distribution. This value is also referred to as “median diameter”. D50 can be measured by a laser diffraction particle size distribution analyzer (for example, Microtrac HRA manufactured by Nikkiso Co., Ltd.) using water as a dispersion medium.

### Negative Electrodes

Each negative electrode 30 is configured to have the at least one negative electrode composite material layer on the entire surface of a negative electrode core except for an area on the negative electrode tab 33 side. The negative electrode core may be a metal foil which is made of a metal stable in the battery operational voltage range, such as copper, or a film or the like coated with such a metal. The thickness of the negative electrode core may be, for example, 3 μm to 15 μm, more preferably, 5 μm to 10 μm.

The negative electrode composite material layer may contain, for example, a negative electrode active material and a binding material, and may be formed on each side of the negative electrode core. The negative electrode composite material layer may be formed around the bottom of the negative electrode tab 33. The thickness of the negative electrode composite material layer on each side of the negative electrode core is, for example, 40 μm to 120 μm, more preferably, 50 μm to 80 μm. Each negative electrode 30 may be manufactured by forming the negative electrode composite material layer on each side of the negative electrode core by applying a negative electrode composite material slurry including a negative electrode active material, a binding material, and other materials to the negative electrode core, and drying and compressing the coating, and then cutting into a preset shape.

The negative electrode active material may be, for example, a carbon-based active material that can reversibly occlude or release lithium ions. The carbon-based active material may be natural graphite, such as flake graphite, vein graphite, or amorphous graphite, or synthetic graphite, such as massive artificial graphite (MAG) or graphitized mesocarbon microbeads (MCMB). Alternatively, the negative electrode active material may be an Si-based active material that contains at least one of Si and an Si-containing compound, or a combination of a carbon-based active material and an Si-based active material.

Although the binding material in the negative electrode composite material layer may be a fluororesin, PAN, a polyimide resin, an acrylic resin, or a polyolefin resin as for the positive electrode 20, it is more preferable to use a styrene-butadiene rubber (SBR). The negative electrode composite material layer may contain CMC or its salt, polyacrylic acid (PAA) or its salt, polyvinyl alcohol (PVA), or the like. It is particularly preferable to use SBR together with CMC or its salt, and PAA or its salt.

Similarly as for the positive electrode 20, each negative electrode 30 may include a core exposed portion in which the negative electrode core is exposed, and a base portion in which the negative electrode composite material layer is formed on each side of the negative electrode core. The base portion may include a first region in which a negative active material is embedded in the negative electrode core and a second region in which a negative active material is not embedded in the negative electrode core as deep as in the first region.

The non-aqueous electrolyte secondary battery 10 according to an embodiment of the present disclosure can prevent the positive electrode composite material layer 22 from peeling off the positive electrode core 21 in the first region 26, and also prevent the electrode from being torn in the second region 27.

### Manufacturing Method of Non-Aqueous Electrolyte Secondary Battery

A method for manufacturing the non-aqueous electrolyte secondary battery 10 of the above described configuration according to an embodiment of the present disclosure is described below. The method for manufacturing the non-aqueous electrolyte secondary battery 10 includes steps of manufacturing the positive electrodes 20, manufacturing the negative electrodes 30, manufacturing the electrode assembly 11 using the positive electrodes 20 and the negative electrodes 30, and after inserting the electrode assembly 11 in the can housing 14, injecting a non-aqueous electrolyte into the can housing 14. For the elements in the electrode assembly 11, such as the positive electrode materials, negative electrode materials, and the separators 40, conventional materials may be used.

The manufacturing process of the positive electrodes 20 includes a coating step to apply a positive electrode composite material slurry including a positive electrode active material on a long piece of the metal foil 50 which is to be used as the positive electrode core 21, a compressing step to dry and roll the coating to form the positive electrode composite material layer 22 on each side of the metal foil 50, and a cutting step to cut the metal foil 50 to a preset shape. In the description below, the direction in perpendicular to the feeding direction of the metal foil 50 is referred to as “width direction”.

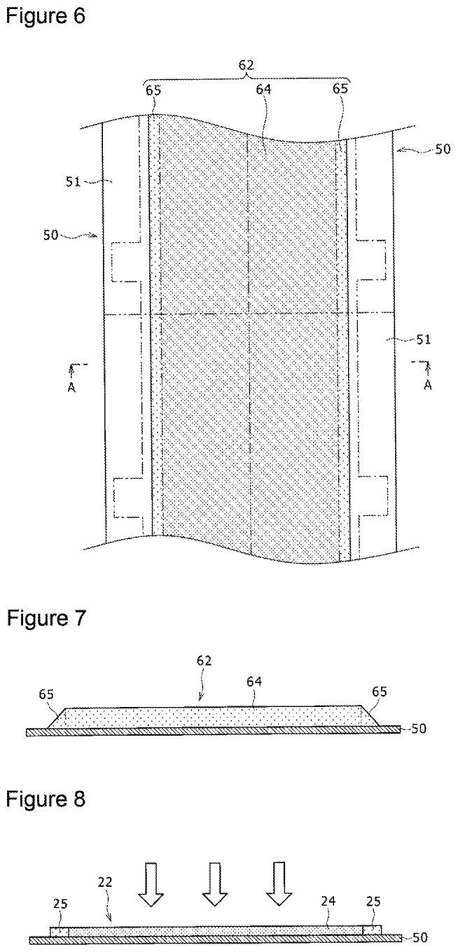

FIG. 6 is a schematic view to illustrate the manufacturing process of the positive electrode 20. As shown in FIG. 6, in the coating step, the positive electrode composite material slurry is applied to the surfaces of the metal foil 50 using a well-known coating applicator, such as a gravure coater, a slit coater, a die coater, or the like. The positive electrode composite material slurry is applied to the metal foil 50 except for exposed portions 51 of a predetermined width from respective edges of the metal foil 50. The core exposed portion 24 and the positive electrode tab 23 described above are formed in the exposed portions 51.

In the coating step, a coating 62 is formed by applying the positive electrode composite material slurry to the metal foil 50. The coating 62 includes a first coating portion 64 and a second coating portion 65 next to the first coating portion 64. The amount of coating per unit area in the second coating portion 65 is less than that in the first coating portion 64. In the description below, a simple recitation “the amount of coating” indicates the amount of coating per unit area. The second coating portion 65 is formed around the boundary with the exposed portion 51. The width of each second coating portion 65 may be 10 mm or less from the boundary with the exposed portion 51.

FIG. 7 is a cross section cut along line A-A in FIG. 6. In the example shown in FIG. 7, the amount of coating with the positive electrode composite material slurry is adjusted such that the cross section perpendicular to the feeding direction has a trapezoid shape. In the cross sectional shape, the cross section of the first coating portion 64 has a stripe shape, whereas the cross sections of the second coating portions 65 have a triangular shape. In other words, the amount of coating in the first coating portion 64 is constant along the width direction. The amount of coating in the second coating portion 65 decreases to zero from the amount substantially same as in the first coating portion 64.

In the compressing step, after the coating is heated and dried, the coating is fed in a predetermined direction while being compressed through mill rolls or the like. FIG. 8 shows a cross section cut along line A-A in FIG. 6. In the example shown in FIG. 8, in the compressing step, the first coating portion 64 is formed as the positive electrode composite material layers 22 in the first region 26 described above, whereas the second coating portions 65 are formed as the positive electrode composite material layers 22 in the second region 27. The density in the second region 27 becomes smaller than that in the first region 26 after the compressing step.

A stress may be concentrated at the edge portions along the feeding direction of the metal foil 50 due to torsion of the metal foil 50 or other causes. This causes a risk of the metal foil 50 being tom in the second region 27 around the boundary with the exposed portion 51 during being fed in the compressing step. In the cutting step, the positive electrode composite material layer 22 may easily peel off the metal foil 50 when cutting the metal foil 50 with the positive electrode composite material layers 22 using a slitter or other means.

In the present embodiment, the binding force between the metal foil 50 and the positive electrode composite material layer 22 in the first region 26 is increased. This can prevent the positive electrode composite material layer 22 from peeling off the metal foil 50 when cutting the metal foil 50 with the positive electrode composite material layers 22 using a slitter or other means in the cutting step. The strength of the metal foil 50 higher than in the first region 26 can be obtained in the second region 27. The positive electrode composite material layer 22 can thus be prevented from being torn in the second region 27 during being fed in the compressing step.

The amount of coating with the positive electrode composite material slurry may be adjusted such that the cross section perpendicular to the feeding direction has an elongated half ellipse shape. In this cross section, the cross section of the first coating portion 64 has a strip-like rectangular shape, whereas the cross sections of the second coating portions 65 has a half ellipse shape.

The amount of coating with the positive electrode composite material slurry may be adjusted such that the cross section perpendicular to the feeding direction has a stepped shape. In this cross section, the cross section of the first coating portion 64 has a strip-like rectangular shape, whereas the cross sections of the second coating portions 65 also have a rectangular shape but lower than the first coating portion 64. In other words, in the first coating portion 64, the amount of coating is adjusted to be constant along the width direction, whereas, in the second coating portion 65, the amount of coating is adjusted to be also constant along the width direction but at an amount less than that in the first coating portion 64.

In the cutting step, the metal foil 50 may be cut using a well-known conventional method such as a laser radiation or a punching die processing. In FIG. 6, the portion to be cut is illustrated with dash-dot lines. The metal foil 50, on both sides of which the positive electrode composite material layers 22 are formed with the positive electrode composite material slurry applied, is cut along the longitudinal direction at the lateral center, and also along the width direction to the predetermined length which equals to the horizontal length of the positive electrode 20. The metal foil 50 is cut along the border between the positive electrode composite material layers 22 and the exposed portions 51 in a longitudinal direction. The positive electrode tabs 23 are cut out by cutting the exposed portions 51 at predetermined intervals.

In the manufacturing processes of the non-aqueous electrolyte secondary battery 10, the electrode assembly 11 is inserted into the can housing 14 after fastening the positive electrode tabs 23 of the positive electrodes 20 to the positive electrode current collectors, and also the negative electrode tabs 33 of the negative electrodes 30 to the negative electrode current collectors.

The manufacturing processes of the non-aqueous electrolyte secondary battery 10 according to embodiments of the present disclosure can prevent the positive electrode composite material layer 22 from peeling off the positive electrode core 21 in the first region 26 in the cutting step, and further prevent the electrodes from being torn in the second region 27 during being fed in the compression step.

The present disclosure is not limited to the above described embodiments or their variations. A variety of changes and improvements are certainly possible within the scope of matters described in the attached claims of the present application.

### REFERENCE SIGNS LIST

10 Non-aqueous electrolyte secondary battery
11 Electrode assembly
12 Positive electrode terminal
13 Negative electrode terminal
14 Can housing
15 Sealing plate
16 Solution inlet
17 Gas outlet valve
20 Positive electrode
21 Positive electrode core
22 Positive electrode composite material layer
23 Positive electrode tab
24 Core exposed portion
25 Base portion
26 First region
27 Second region
30 Negative electrode
33 Negative electrode tab
40 Separator
50 Metal foil
51 Exposed portion
62 Coating portion
64 First coating portion
65 Second coating portion

1. A non-aqueous electrolyte secondary battery comprising a non-aqueous electrolyte and an electrode assembly in which a plurality of positive electrodes and a plurality of negative electrodes are alternately stacked via a plurality of separators, each of the plurality of positive electrodes and the plurality of negative electrodes comprising a core exposed portion in which a core is exposed, and a base portion in which a composite material layer is formed on at least one side of the core,
wherein the base portion comprises a first region in which an active material is embedded in the core and a second region in which the average embedment depth of the active material in the core is smaller than that in the first region, and
the second region is located next to the core exposed portion.

2. The non-aqueous electrolyte secondary battery according to claim 1, wherein
the surface curve rate of the core in the first region is 110% to 150%.

3. The non-aqueous electrolyte secondary battery according to claim 1, wherein
the second region is formed in an area within 10 mm or less from a boundary with the core exposed portion.

4. A method for manufacturing a non-aqueous electrolyte secondary battery comprising a non-aqueous electrolyte and an electrode assembly in which a plurality of positive electrodes and a plurality of negative electrodes are alternately stacked via a plurality of separators, each of the plurality of positive electrodes and the plurality of negative electrodes comprising a core exposed portion in which a core is exposed, and a base portion in which a composite material layer is formed on at least one side of the core, the method comprising:
applying a composite material containing an active material to at least one side of a metal foil that forms the core, leaving an exposed portion that includes the core exposed portion to manufacture the plurality of positive electrodes or the plurality of negative electrodes,
wherein, in the coating, the composite material is applied to form a first coating portion and a second coating portion in which the amount of coating per unit area is less than that in the first coating portion, and
the second coating portion is located next to the exposed portion.

5. The method for manufacturing the non-aqueous electrolyte secondary battery according to claim 4, wherein
the second coating portion has a width of 10 mm or less from a boundary with the exposed portion.
